(19) United States
(12) Patent Application Publication
(10) Pub. No.: US 2017/0005685 A1
(43) Pub. Date: Jan. 5, 2017

(54) SCREEN COVER AND CLEANER

(71) Applicant: Michael Duane Kiser, Pearland, TX (US)

(72) Inventor: Michael Duane Kiser, Pearland, TX (US)

(21) Appl. No.: 15/148,915

(22) Filed: May 6, 2016

Related U.S. Application Data
(60) Provisional application No. 62/187,251, filed on Jul. 1, 2015.

(51) Int. Cl. H04B 1/3888; H04M 1/02

(52) U.S. Cl. CPC H04B 1/3888; H04M 1/0202

(57) ABSTRACT

Embodiments of the present invention provide a apparatus and method for covering and cleaning the screens of electronic devices. Certain embodiments are configured to conveniently, routinely and safely clean the surface of a mobile phone, electronic reader or mini-computing device during its normal use. Embodiments of the screen cleaner attach a cleaning material to the inside surface of a mobile phone or mini-computing device screen cover that is designed to swipe the screen of the device free of smudges, fingerprints and so forth as it is inserted into or removed from the device cover.

### CROSS-REFERENCE TO RELATED APPLICATION

This application claims the benefit of priority from U.S. Provisional Application No. 62/187,251, filed on Jul. 1, 2015, the disclosure of which is hereby incorporated by reference in its entirety.

### BACKGROUND OF THE INVENTION

Field of the Invention

The present invention relates to an electronic device screen cover and cleaner. In particular, the present invention relates to a mobile phone, electronic reader or mini-computer screen cover and cleaner.

Description of the Related Art

On a daily basis, mobile phone screens attract a lot of dust, dirt, fingerprints, or other matter, routinely leaving the screen a mess. The mobile phone industry has investigated a tremendous amount of time and money to solve the “smudge” problem on their glass screens. Currently, mobile phone users will swipe or rub their mobile phone screen on their pants, shirts, blouses and upholstery, as well as resorting to the use of glass cleaners and paper towels.

Since efforts to create a glass or other transparent material that does not smudge, smear or fingerprint have been unsuccessful, a number of products have been developed to manually clean the screens. Typical methods for cleaning a mobile phone's screen include various methods for “wiping” the screens, using a cleaning material, typically a glass cleaning cloth or matt, of various sizes and designs. These cleaning materials are either attached to the mobile phone by a mount made of Velcro™ or affixed to the back of the phone, its case, or its belt clip. Some cleaning devices are attached to something other than the phone, while others are separate cleaning tools that are kept in the pocket, purse, briefcase, etc.

All of the available cleaning devices must be removed from the mount, pocket, purse, briefcase, etc., and utilized to clean the screen. After use, the cleaning device must be re-attached to the mount, or returned to the pocket, purse, briefcase, or other location where the device was kept.

One cleaning device, with a different design and method of application, is a pouch that is lined with a cleaning material. The phone user must detach his phone from its belt clip case or purse and insert the phone into the top of the pouch. The user must then “pinch” or apply pressure to the cleaning material lining the interior of the pouch across the surface of the screen, while pulling the phone out of the pouch to be replaced in its carrier.

A need exists for an improved cleaning device and method that will conveniently, routinely clean the surface of a mobile phone during its normal use.

### SUMMARY OF THE INVENTION

Embodiments of the present invention provide a apparatus and method for covering and cleaning the screens of electronic devices. Certain embodiments are configured to conveniently, routinely and safely clean the surface of a mobile phone, electronic reader or mini-computing device during its normal use. Embodiments of the screen cleaner attach a cleaning material to the inside surface of a mobile phone or mini-computing device screen cover that is designed to swipe the screen of the device free of smudges, fingerprints and so forth as it is inserted into or removed from the device cover.

One embodiment of the present invention is a screen cover including: a back plate having a front side and a back side; a cleaning material mounted on the front side of the back plate; two mirror image side retaining rails, wherein each side retaining rail has a first surface having one end vertically mounted to one side of the back plate and a second opposed end attached at an angle to a second surface wherein the second surface extends over a portion of the front side of the back plate; an end retaining rail attached to a back end of the back plate; and an insertion end of the screen cover.

Another embodiment of the invention is a screen cover including: a back plate having a front side and a back side; a microfiber cloth mounted on the front side of the back plate; two mirror image side retaining rails, wherein each side retaining rail has a first surface having one end vertically mounted to one side of the back plate and a second opposed end attached at an angle to a second surface wherein the second surface extends over a portion of the front side of the back plate; an end retaining rail attached to a back end of the back plate and curved over a portion of the back plate; and an insertion end of the screen cover.

Yet another embodiment of the present invention is a method for cleaning an electronic device screen including: obtaining a screen cover dimensionally configured to fit a particular electronic device having a screen, wherein the screen cover has a back plate having a front side and a back side, a cleaning material mounted on the front side of the back plate, two mirror image side retaining rails wherein each side retaining rail has a first surface having one end vertically mounted to one side of the back plate and a second opposed end attached at an angle to a second surface wherein the second surface extends over a portion of the front side of the back plate, an end retaining rail attached to a back end of the back plate, and an insertion end of the screen cover; aligning opposed sides of the electronic device to slide between the cleaning material and the second surface of the two side retaining rails; inserting one end of the electronic device with its screen facing the cleaning material into the screen cover by sliding the electronic device from the insertion end to the end retaining rail between the cleaning material and the second surface of the two side retaining rails; and withdrawing the electronic device from the screen cover thereby swiping the screen across the cleaning material.

The foregoing has outlined rather broadly several aspects of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 A is a perspective view of one embodiment of a screen cover and cleaner with a cleaning material attached to an inside surface;

FIG. 1B is a rear view of the screen cover shown in FIG. 1A having a clip or holder mounted thereon;

FIG. 2 is a perspective view of a second embodiment of the screen cover and cleaner with a cleaning material attached to an inside surface;

FIG. 3 is a perspective view of a third embodiment of the screen cover and cleaner with a cleaning material attached to an inside surface;

FIG. 4 is perspective view of a fourth embodiment of the screen cover and cleaner with a cleaning material attached to an inside surface and an outside surface;

FIG. 5A is rear view of any one of the first, second or third embodiments of the phone case; and

FIG. 5B is an enlarged view of a corner of the fifth embodiment of the screen cover and cleaner shown in FIG. 5A.

### DESCRIPTION OF THE PREFERRED EMBODIMENTS

Embodiments of the invention provide an improved screen cleaning device that will conveniently, routinely and safely clean the screen surface of a mobile phone or mini-computer during its normal use. Embodiments of the present invention attach a cleaning material to the inside surface of the mobile phone or mini-computing screen cover that is designed to swipe the screen of the device as it is inserted into or removed from the cover.

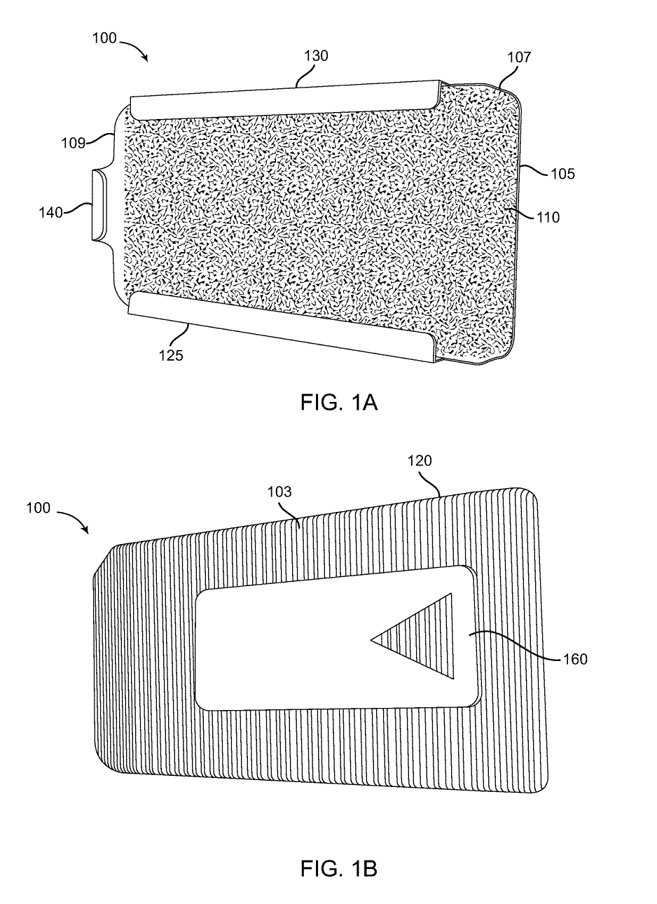

FIG. 1A illustrates one embodiment of a screen cover 100 configured to clean the screen of a mobile phone as it is inserted screen down into and removed from the screen cover. The screen cover has a cleaning material 110 attached to the inside surface of the screen cover 100 that is in contact with the glass screen of the device when it is inserted into the cover 100. This cleaning material 110 is arranged such that, when the phone is inserted into and removed from the cover 100, the material 110 will swipe the screen clean and remove smudges, fingerprints, make up, facial oil, etc.

### The Screen Cover

The screen cover 100 shown in FIGS. 1A and 1B has a back plate 103, two mirror image sides 120, and retaining rails 125. The screen cover has an insertion end 105 for the insertion of a phone or mini-computing device, an opposed back end 109 with an end retaining rail 140, and two side retaining rails 130. A cleaning material 110 is attached to a front planar surface of the back plate 103 and an optional clip or fastener 160 may be attached to the back side of the back plate that is used to attach the screen cover to a belt, pocket, purse, back pack, etc.

Multiple embodiments of the screen cover are configured for different types of phones, electronic readers, mini-computers or pads. Different embodiments will often have variations in the design and dimensions of the side retaining rails, the end retaining rails and the insertion ends. The typical screen cover designed to hold a mobile phone has a rectangular shape. Preferred embodiments of these screen covers are designed with the insertion end along a width of the screen cover (i.e., a shorter side of the rectangle). Thus, when the phone or device is inserted lengthwise into the screen cover, the screen is efficiently cleaned due to the longer distance of the swiping effect of the screen on the cleaning material. Screen covers with the opening end along a length of the screen cover (i.e., a longer side of the rectangle) will have a shorter distance of travel of the screen against the cleaning material during the swipe.

### Cleaning Material

A number of materials will work as the attached cleaning material 110, 210, 310, 410. One of the most effective materials is a microfiber cloth. Unlike paper-based towels, microfiber cloths gently clean electronic device's sensitive glass screens without running the risk of scratching them. A microfiber cloth attracts any oils or dust present on the device's screen and completely removes them, as opposed to just wiping them around. Mobile phones are susceptible to facial oil, fingerprints, and make-up and the microfiber cloth is remarkably efficient and cleaning the phone's screen without scratching the screen. A preferred embodiment of the cleaning material 110 is a matt material made of microfibers that has loops or pile, similar to terry cloth or carpet. In numerous experiments conducted with many types of cloths and materials, a microfiber mitt made for washing cars, which has a ⅜″ thick pile, provided the best performance with consistent results.

The screen cover 100 functions best when a moderate pressure is continually maintained between the screen of the phone or device and the cleaning material. The side retaining rails are configured to hold the phone snugly against the cleaning material whenever it is mounted in the screen cover. The end retaining rail is also configured to assist in holding the phone securely in the screen cover.

### Retaining Rails

Various embodiments of the screen cover have different dimensions and configurations for the side retaining rails and the end retaining rail. Generally, the side retaining rails have two surfaces that are attached to each other at an angle varying from a 70 degree angle to a 110 degree angle and preferably about a 90 degree angle. Thus, if the first surface is vertically mounted on a first side of the back plate of the screen cover then the second surface will extend inward over the back plate. If the back plate is planar and the second surface is attached perpendicularly to the first surface, then the second surface will extend over the back plate in a substantially parallel manner.

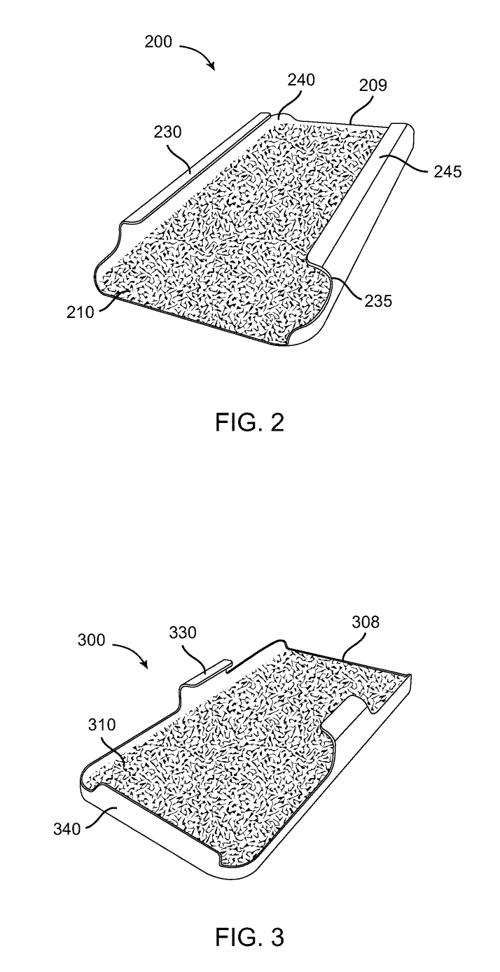

For example, the embodiment of the screen cover 100, 200 shown in FIGS. 1A and 2 have longer side retaining rails 130, 230 than the side retaining rails 330 of the screen cover 300 shown in FIG. 3. The longer retaining rails 130, 230 will hold the phone's screen firmly against the cleaning material 110, 210 for the full length of the screen as it is inserted and removed from the screen cover 100, 200. In addition, the insertion end of the side retaining rails may have different configurations to ease the insertion of the phone/device into the screen cover and alignment the groove of the side retaining rails. For example, the side retaining rails 230 have arcuate front ends 235 to ease the insertion of a phone/device into the cover.

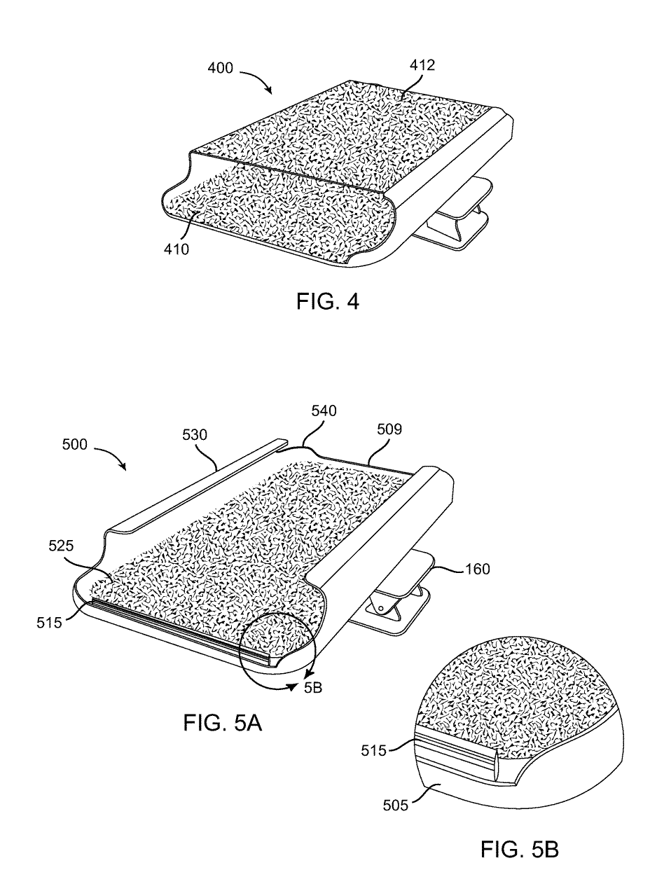

The side retaining rails of the screen cover of different embodiments not only have different lengths, but the top side 245 of the side retaining rail may also extend across the top of the screen cover toward each other with a variety of widths. In fact, one embodiment of the screen cover 400 has its top side of the side retaining rails extending totally across the top of the screen cover forming a solid surface as illustrated in FIG. 4. This embodiment provides a case that protects the back side of the phone/device as well as cleaning the screen on the front side of the device during insertion and withdrawal from the case. The cleaning material 410 is attached to the front side of the back plate. In this embodiment of the screen cover a similar cleaning material 412 may be attached to the top outer surface of the screen cover 400. This external cleaning material 412 can easily be used to clean screens on larger devices, such as mini-computers or electronic readers.

As seen in FIGS. 1A, 2 and 3, the size of the end retaining rail is generally inversely variable to the length of the side retaining rails. For example, the screen cover 100 shown in FIG. 1A has long side retaining rails 130 and a short end retaining rail 140; whereas the screen cover 300 shown in FIG. 3 has shorter side retaining rails 330 and a longer end retaining rail 340. Other examples shown in FIGS. 2 and 5A, have side retaining rails 230, 530 that extend nearly to the back end 209, 509 of the cover 200, 500 where the back end 209, 509 is a short vertically extending side transverse to the planar surface of the back plate with two small lips or end retaining rail 240, 540 that curve inward at opposed sides of the back end 209, 509.

### Open End

There are also a number of variations in the configuration of the insertion end of the screen cover where the phone/device is inserted into the cover. For example, the insertion end may have a substantially straight outer edge 308 as illustrated in FIG. 3, or the outer edge may have chamfered corners 107 as shown in FIG. 1A. Currently available telephone covers that protect the back surface and sides of a phone will typically have a small lip on the end where the phone is inserted, to prevent it from sliding out. Since the screen cover of the present invention has retaining rails to hold the phone or device more securely, along with the cleaning material which resists sliding, such a lip on the insertion end of the device is not needed or desired.

### Screen Washer

Alternative embodiments of the screen cover with similar dimensions and designs as those described above, will have an absorbent material 525 attached to the front side of the back plate, as shown in screen cover 500. This absorbent material 525 is selected for its ability to hold a cleaning fluid within its interstitial matrix. As an example, the absorbent material may be a sponge-type material or similar to the material used in diapers or feminine pads. Although a microfiber material, such as described above for the cleaning material, may be used the less absorbent materials will require more frequent wetting. Typically absorbent materials that can hold more cleaning fluid, without dripping or feeling wet, are better. These absorbent materials will also resist loss of the cleaning fluid by evaporation, allowing longer service life before needing to be rewet.

Thus when the phone/device is inserted into the screen cover 500, the screen of the device will be in contact with the absorbent material 525 and the cleaning fluid held within its interstitial matrix. A small flexible elastomeric or squeegee-type edge 515 is affixed to the top edge of the insertion end 505 to swipe off any liquid residue on the screen and provide a final screen cleaning and drying action on the screen. A liquid cleaner will have to be re-applied to the absorbent material 525 periodically. A typical glass cleaning fluid works well in this design.

It should be appreciated by those skilled in the art that the conception and the specific embodiments disclosed herein might be readily utilized as a basis for modifying or redesigning the configuration and structure of the screen cover for carrying out the same purposes as the described embodiments. It should be realized by those skilled in the art that such equivalent constructions do not depart from the spirit and scope of the invention as set forth in the appended claims.

What is claimed is:

1. A screen cover including:
a. a back plate having a front side and a back side;
b. a cleaning material mounted on the front side of the back plate;
c. two mirror image side retaining rails, wherein each side retaining rail has a first surface having one end vertically mounted to one side of the back plate and a second opposed end attached at an angle to a second surface wherein the second surface extends over a portion of the front side of the back plate;
d. an end retaining rail attached to a back end of the back plate; and
e. an insertion end of the screen cover.

2. The screen cover of claim 1, wherein the cleaning material is mounted on a planar surface on the front side of the back plate.

3. The screen cover of claim 1, wherein the cleaning material is a microfiber cloth.

4. The screen cover of claim 2, wherein the cleaning material is an absorbent material.

5. The screen cover of claim 1, wherein the back plate is rectangular and the insertion end includes a shorter side of the back plate and the end retaining rail is attached to an opposed side of the back plate from the insertion end.

6. The screen cover of claim 1, wherein the second surface of the side retaining rail is substantially parallel to the back plate.

7. The screen cover of claim 1, wherein the second surface of the side retaining rail is substantially perpendicular to the first surface of the side retaining rail.

8. The screen cover of claim 1, wherein the second surfaces of the two side retaining rails extend substantially over the entire surface of the cleaning material.

9. The screen cover of claim 1, wherein the second surfaces of the two side retaining rails merge into a front panel of the screen cover.

10. The screen cover of claim 9, wherein a second cleaning material is mounted on an outer surface of the front panel.

11. The screen cover of claim 1, wherein a front end of the side retaining rails facing the insertion end is arcuate.

12. The screen cover of claim 1, wherein the insertion end has chamfered corners.

13. The screen cover of claim 4, further comprising a flexible elastomeric squeegee edge mounted on a top side of the insertion end.

14. A screen cover including:
a. a back plate having a front side and a back side;
b. a microfiber cloth mounted on the front side of the back plate;
c. two mirror image side retaining rails, wherein each side retaining rail has a first surface having one end vertically mounted to one side of the back plate and a second opposed end attached at an angle to a second surface wherein the second surface extends over a portion of the front side of the back plate;
d. an end retaining rail attached to a back end of the back plate and curved over a portion of the back plate; and
e. an insertion end of the screen cover.

15. A method for cleaning an electronic device screen including:
a. obtaining a screen cover dimensionally configured to fit a particular electronic device having a screen, wherein the screen cover has
(i) a back plate having a front side and a back side,
(ii) a cleaning material mounted on the front side of the back plate,
(iii) two mirror image side retaining rails wherein each side retaining rail has a first surface having one end vertically mounted to one side of the back plate and a second opposed end attached at an angle to a second surface wherein the second surface extends over a portion of the front side of the back plate,
(iv) an end retaining rail attached to a back end of the back plate, and
(v) an insertion end of the screen cover;
b. aligning opposed sides of the electronic device to slide between the cleaning material and the second surface of the two side retaining rails;
c. inserting one end of the electronic device with its screen facing the cleaning material into the screen cover by sliding the electronic device from the insertion end to the end retaining rail between the cleaning material and the second surface of the two side retaining rails; and
d. withdrawing the electronic device from the screen cover thereby swiping the screen across the cleaning material.
